(19) United States
(12) Patent Application Publication
(10) Pub. No.: US 2022/0297837 A1
(43) Pub. Date: Sep. 22, 2022

(54) BRIDLE FOR A VEHICLE

(71) Applicant: Grant CALVERLEY, Bremerton, WA (US)

(72) Inventor: Grant CALVERLEY, Bremerton, WA (US)

(21) Appl. No.: 17/695,273

(22) Filed: Mar. 15, 2022

Related U.S. Application Data
(60) Provisional application No. 63/162,236, filed on Mar. 17, 2021.

(51) Int. Cl. B64D 1/22; B64C 27/04

(52) U.S. Cl. CPC B64D 1/22; B64C 27/04

(57) ABSTRACT

The present disclosure discloses a bridle for a vehicle. The bridle being connected to the vehicle and which creates a pivot point located at a location selected from: above the vehicle's center of gravity and below or at the center of lift of the vehicle, when the center of gravity is below the center of lift; below the center of gravity of the vehicle and below or at the center of lift of the vehicle, when the is located above the center of lift; and at the center of gravity of the vehicle when the center of lift is in the same approximate location of the center of gravity of the vehicle.

### FIELD OF THE INVENTION

The present invention relates to bridles for vehicles.

### Definitions

As used in the present disclosure, the following terms are generally intended to have the meaning as set forth below, except to the extent that the context in which they are used indicate otherwise.

Bridle: The term “Bridle/Bridling arrangement” used herein after in this specification refers to a term used for any mechanism by which a tether consisting of a rigid, semi-rigid or a flexible member is attached to a location, or locations associated with a vehicle, either to enable the vehicle to be pulled or kited, or to enable the vehicle to pull or lift a vehicle, a load or a device or operate a device connected to the free end of the tether.

Fixture: The term “Fixture” used herein after in this specification is intended to mean a plurality of linkages connected to each other to form a frame having a geometric or non-geometric configuration.

Pivot Point: The term “Pivot Point” used herein after in this specification refers to a point in space, within or near the vehicle or associated with the vehicle that acts like a hinge or pivot about which the tethered vehicle rotates due to changes in the vehicles aerodynamic/hydrodynamic torque and of the vehicles weight torque.

Center of Lift/Pressure (CL/CP): The term “Center of Lift/Pressure” used herein after in this specification refers to a point in space within or near the vehicle through which the average of all the vehicles aerodynamic/hydrodynamic force passes.

Center of Gravity (CG): The term “Center of Gravity” used herein after refers to a single point in space, within or near the vehicle which is the average location of the weight of all the parts of the vehicle.

Hub: The term “Hub” used hereinafter in this specification refers to the attachment point of the rotor blades of a vehicle.

Connecting linkage: The term “Connecting linkage” used herein after in this specification refers to connection link of the fixture to be attached to the hub or fuselage of a vehicle.

Side linkages: The term “Side linkages” used herein after in this specification refers to linkages connected to either side of the connecting linkage.

Bottom linkage: The term “Bottom linkage” used hereinafter in this specification refers to a linkage configured to be connected (parallel to the connecting linkage) to the two side linkage to allow a tether to be attached thereon to form the bridle structure.

Tether: The term “Tether” used herein after in this specification refers to generally a flexible elongate element secured between the bridle attachment mechanism on the vehicle and any other object.

Moment arm: The term “Moment arm” used herein after in this specification refers to the length between a joint axis and the line of force acting on that joint.

Swashplate: The term “Swashplate” used herein after in this specification refers to a device that translates input via the helicopter flight controls into motion of the main rotor blades.

Aquatic Vehicle: The term “Aquatic Vehicle” used herein after refers to a vehicle which floats on water, which is driven underwater or which can be lowered or raised.

### BACKGROUND

Bridles are employed generally for towing a vehicle or are attached to the vehicle to tow an external body, or to attach a vehicle to a fixed or moveable position on the ground or water or in the air. The bridle, conventionally, comprises one, two, three, or four non-parallel and convergent linkages joined together by means of ball joints, or flexible rope or tensile materials, and configured to lift, tow, or tether loads to a platform or vehicle, in an operative configuration. The bridle is typically attached to the bottom or rear of the vehicle for lifting or towing an external load, or is attached to the nose or bottom of the fuselage of the vehicle to facilitate tethering or towing of the vehicle. The vehicle may be a land vehicle, an air vehicle or a sea vehicle, particularly an air or sea vehicle, where the vehicle tends to be buffeted as a result of strong winds or waves, particularly in inclement weather. As a result, load is exerted on the coupling element connecting the bridle and the vehicle. In typical configurations, a bridle creates a long moment arm between the bridle's attachment point on the vehicle and the vehicle's Centre of Gravity (CG) or Centre of Pressure/Lift (CP/CL). This can significantly and unpredictably change the balance of the vehicle creating an imbalance in the forces acting on the vehicle, thereby potentially causing the vehicle to go out of control.

On the other hand, airborne vehicles as, kites and tethered gyro gliders also need to be tethered to a platform while flying in high velocity wind or water stream. Typically, one end of the tether is attached to the bottom or front end or nose of the glider or kite, whereas the other end of the tether is attached to a platform or the earth. Due to the strong winds or currents however, the attachment point at the front or bottom of the vehicle, is well below or in front of the Centre of Pressure/Lift of the vehicle thus creating a long moment arm. As a result, it becomes necessary that the vehicle's control authority must overcome this moment arm in order to control the vehicle. As the energy density of wind or currents intensifies as the speed increases, the vehicle's control authority must also intensify at the same rate to overcome this built-in moment arm. If the winds or currents exceed the threshold of the vehicle's control authority and the aforementioned moment arm, it can cause aerodynamic imbalance of the kite or glider rotor, and thereby potentially causing the vehicle to go out of control. In some current instances of the tethered vehicle, a tail is used with optionally an elevator, a rudder, a tail rotor, or a weather vane type controls to help overcome the aforementioned bridle attachment point's moment arm. While this can help with the control authority, the tail surface's control authority is limited in extreme tethered manoeuvres and can also cause unpredictable and dangerous outcomes in wind gusts.

There is therefore felt a need for a bridle that alleviates the aforementioned drawbacks.

### Objects

Some of the objects of the present disclosure, which at least one embodiment herein satisfies, are as follows:

An object of the present disclosure is to provide a bridle for a vehicle.

Another object of the present disclosure is to provide a bridle for a vehicle, which provides agility, stability to the vehicle while being tethered to an external body.

Another object of the present disclosure is to provide a bridle for a vehicle, which works either when, said vehicle is being towed or tethered to an external body or when the said vehicle is pulling or lifting the external body.

Yet another object of the present disclosure is to provide a bridle for a vehicle, which has relatively better roll, pitch, and yaw stability and capabilities.

Another object of the present disclosure is to provide a bridle for a vehicle, which requires less number of structural components, including the optional omission of a tail structure with optional elements such as elevator, rudder, tail rotor or weather vane control surfaces.

Another object of the present disclosure is to provide a method of landing and launching a tethered object with this new bridle configuration.

Still another object of the present disclosure is to provide a bridle for a vehicle that provides better safety and control while launching and landing the vehicle.

Yet another object of the present disclosure is to provide a bridle for a vehicle that requires less number of structural components, including making the entire tail structure and components optional.

Other objects and advantages of the present disclosure will be more apparent from the following description, which is not intended to limit the scope of the present disclosure.

### SUMMARY

The present disclosure discloses a bridle for a vehicle. The bridle being connected to the vehicle and which creates a pivot point located at a location selected from: above the vehicle's center of gravity and below or at the center of lift (CL) of the vehicle when the center of gravity (CG) is below the center of lift (CL); below the center of gravity (CG) of the vehicle and below or at the center of lift (CL) of the vehicle, when the center of gravity (CG) is located above the center of lift (CL); and at the center of gravity (CG) of the vehicle when the center of lift (CL) is in the same approximate location of the center of gravity (CG) of the vehicle.

In an embodiment, the bridle includes a tether, and the tether is connected to the pivot point.

In another embodiment, the bridle includes a tether and a fixture. The fixture creates the pivot point and the tether is attached to the fixture.

In an embodiment, the fixture comprises connecting linkages, side linkages, at least one bottom linkage, and a tether. The connecting linkages are configured to be attached and create the pivot point. The side linkages are configured to be attached to the ends of the connecting linkages. The bottom linkage is configured to be attached to the side linkages to form a bridle structure. The tether is configured to be attached to the bottom linkage at tether attachment point. The connecting linkage, the side linkages, the bottom linkage, and the tether facilitate transfer of the loads of the vehicle from a pivot point to the tether attachment point.

In an embodiment, the connecting linkages are in two halves on either side of the vehicle adjacent or at the pivot point.

In an embodiment, the two halves of the connecting linkages are pivoted near the hub of the vehicle.

In an embodiment, the pivot point between the two halves of connecting linkages and the tether attachment point on the bottom linkage remains centered to stabilize the vehicle.

In an embodiment, the moment arm between the pivot point and the center of lift is smaller to allow the vehicle to more easily pitch forward and backward and roll side to side.

In another embodiment, the moment arm allows the vehicle to pitch from −10 degrees in a forward direction to +50 degrees in backwards direction.

In an embodiment, the two halves of connecting linkage have same length as the bottom linkage. In another embodiment, the bottom linkage is longer or shorter than the connecting linkage. In still another embodiment, the overall length of the connecting linkage and the bottom linkage is same. In yet another embodiment, the lengths of the connecting linkage and the bottom linkage are equal.

In an embodiment, the side linkages are flexible structures attached to the two halves of connecting linkage and the bottom linkage via universal type flexible joints.

In an embodiment, the side linkages are rigid structures attached to the two halves of connecting linkage and the bottom linkage via wire ropes.

In an embodiment, the bottom linkage is rigid that allows load of the vehicle to transfer to the tether.

In an embodiment, the side linkages and the tether remains parallel to the tether to allow the tether to remain taut.

In an embodiment, the tether and/or side linkages are of a flexible material selected from the group consisting of crystalline plastics, ultra-high molecular weight polyethylene, aramid, carbon fiber, a composite material, and any combination thereof.

In another embodiment, the tether is of an inflexible solid material such as rod.

In an embodiment, the linkages are connected with each other by wire rope and sleeve type structure.

In an embodiment, the wire rope is made of a flexible material selected from the group consisting of braided steel, stainless steel, galvanized steel, nylon coated wire rope, and fiber polyvinyl chloride coated (PVC) wire rope, crystalline plastics, ultra-high molecular weight polyethylene, aramid, carbon fiber, a composite material, and any combination thereof.

In an embodiment, the bridle for use along with an aerial vehicle. In an embodiment, the bridle for use along with an aquatic vehicle. An aerial vehicle having a bridle attached thereto. An aquatic vehicle having a bridle attached thereto.

### BRIEF DESCRIPTION OF THE DRAWINGS

A bridle, of the present disclosure, for a vehicle will now be described with the help of the accompanying drawing, in which:

FIG. 1 illustrates a front view of the bridle attached to a vehicle, specifically a helicopter, in accordance with an embodiment of the present disclosure;

FIG. 2 illustrates a side view of the bridle attached to the helicopter of FIG. 1, and tethered to an anchor point of an external body;

FIG. 3 illustrates a front view of the bridle attached to a tethered gyro glider in a stable flight condition; and

FIG. 4 illustrates a front view of the bridle attached to the gyro glider in FIG. 3 as it executes a flying roll manoeuvre to the left; and

FIGS. 5 to 7 depict a series of landing and launching of the vehicle from a landing vehicle, with the bridle attached to the vehicle.

### LIST OF REFERENCE NUMERALS

A fore and aft pitch action/roll action
CG centre of gravity
CL centre of lift
P pivot point
R rotor
Y yaw action
Y′ tether twist
L low angle
H high angle
100 bridle
105 connecting linkage
110 side linkage
115 bottom linkage
120 rope/tether
125 tether attachment point
200 vehicle
205 rotor/craft's hub
300 landing and launching fixture
400 landing vehicle
410 locking clamp

### DETAILED DESCRIPTION OF THE INVENTION

Embodiments, of the present disclosure, will now be described with reference to the accompanying drawing.

Embodiments are provided so as to thoroughly and fully convey the scope of the present disclosure to the person skilled in the art. Numerous details are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a,” “an,” and “the” may be intended to include the plural forms as well, unless the context clearly suggests otherwise. The terms “comprises,” “comprising,” “including,” and “having,” are open ended transitional phrases and therefore specify the presence of stated features, elements, modules, units and/or components, but do not forbid the presence or addition of one or more other features, integers, steps, operations, elements, components, and/or groups thereof.

When an element is referred to as being “mounted on,” “engaged to,” “connected to,” or “coupled to” another element, it may be directly on, engaged, connected or coupled to the other element. As used herein, the term “and/or” includes any and all combinations of one or more of the associated listed elements.

The terms first, second, third, etc., should not be construed to limit the scope of the present disclosure as the aforementioned terms may be only used to distinguish one element, component, region, layer or section from another component, region, layer or section. Terms such as first, second, third etc., when used herein do not imply a specific sequence or order unless clearly suggested by the present disclosure.

Terms such as “inner,” “outer,” “beneath,” “below,” “lower,” “above,” “upper,” and the like, may be used in the present disclosure to describe relationships between different elements as depicted from the figures.

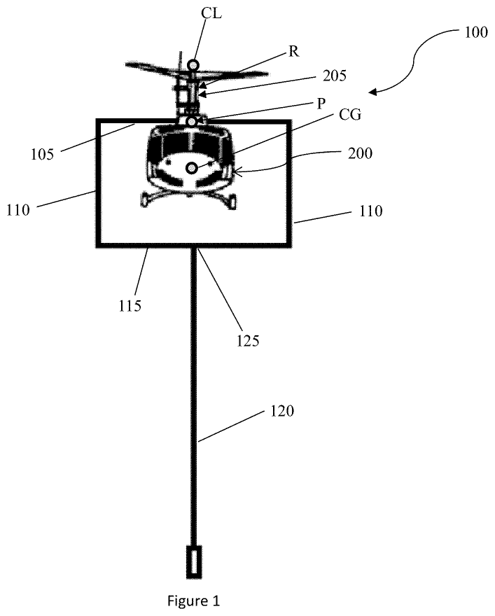

The present disclosure discloses a bridle for a vehicle (200). The bridle (100) (hereinafter referred to as “bridle 100”), of the present disclosure, for a vehicle (200) will now be described with reference to FIG. 1 through FIG. 7.

The bridle (100) is configured to be connected to the vehicle (200) and which creates a pivot point (P) located at a location selected from: above the vehicle's (200) centre of gravity (CG) and below or at the centre of lift (CL) of the vehicle (200) when the centre of gravity (CG) is located below the centre of lift (CL); below the centre of gravity (CG) of the vehicle (200) and below or at the centre of lift (CL) of the vehicle (200), when the centre of gravity (CG) is located above the centre of lift (CL); and at the centre of gravity (CG) of the vehicle when the centre of lift (CL) is in the same approximate location of the centre of gravity (CG) of the vehicle (200).

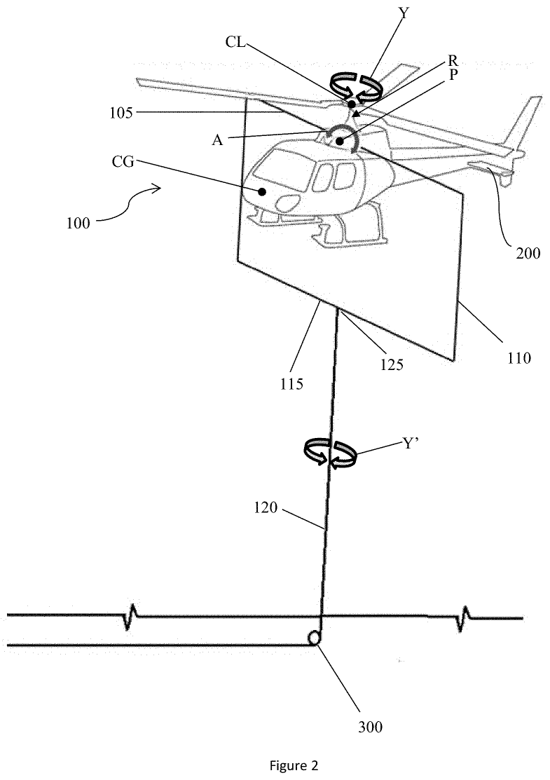

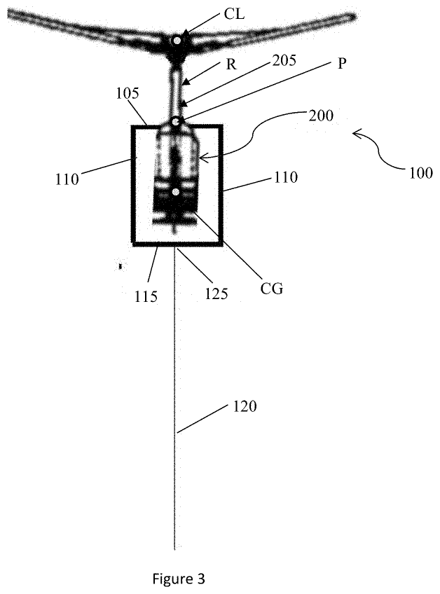

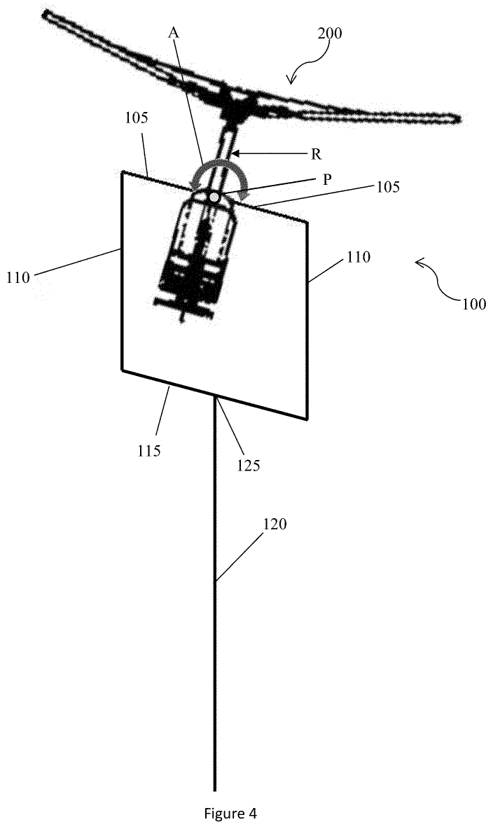

In an embodiment, the present disclosure envisages a bridle (100) for an aerial vehicle (200) such as helicopters, gyro-gliders, and aerial drones, kites that are tethered to an air vehicle carrier, a landing platform, a generator or to an external body that needs to be lifted or towed, or to the earth. In an embodiment, the vehicle (200) is a helicopter (as shown in FIGS. 1 through 2), or a gyro glider (as shown in FIG. 3 through 4). In an embodiment, the bridle (100) also works well with conventional and current fuselage types. As shown in FIG. 2, the vehicle (200) and bridle (100) together rotate along the length of the tether (120) in a twisting fashion (Y′), clockwise or anticlockwise as shown at the same time it may be rolling or pivoting fore, aft motion (A) or side to side.

The preferred embodiment does not limit the scope and ambit of the present disclosure. The vehicle (200) referred to by the present disclosure, is an aerial vehicle, however, the vehicle (200) can also be a land vehicle, a water vehicle, an aquatic vehicle to which the bridle (100) is tethered. The aquatic vehicle could be submarines, submersibles, or vessels such as ships, boats, or trawlers. The bridle (100) can also be tethered to an external body such as a towed or fixed platform, a ground based generator, or an external load. Although, drawing illustrate the bridle (100) attached to an aerial vehicle, it could be also conveniently be used for any land vehicle, any water vehicle, or any aquatic vehicle.

In an embodiment, the bridle (100) includes a tether (120), and the tether (120) is connected to the pivot point (P). In another embodiment, the bridle (100) includes a tether (120) and a fixture, wherein said fixture creates the pivot point (P) and the tether (120) is attached to the fixture. The fixture is intended to mean a plurality of linkages (105, 110, and 115) connected to each other to form a frame having a geometric or non-geometric configuration. The linkages (105, 110, and 115) are connected with each other with the help of universal joints, to form a bridle (100).

The connecting linkages (105) are configured as a two-piece beam or two halves adjacent or at the pivot point (P). The connecting linkages (105) are configured to be attached and create the pivot point (P) associated with the vehicle (200) and which is above the centre of gravity (CG), below or at the centre of lift (CL) of the vehicle (200). The two halves of connecting linkages (105) are attached to the operative top portion of the vehicle (200) in the vicinity of either its Centre of Gravity (CG) or its Centre of Pressure/Lift (CL) of the vehicle (200). More specifically, the two halves of connecting linkages (105) are pivoted near or in the hub (205) of the vehicle (200).

In a preferred embodiment, the connecting linkages (105) of the bridle (100) are configured to be attached to both the left and right sides of the fuselage of the vehicle (200) above the centre of gravity (CG), and below or at the Centre of Pressure/Lift (CL) of the vehicle (200).

In an embodiment, the pivot point (P) between the two halves of connecting linkages (105) and the tether attachment point (125) on the bottom linkage (115) remains centred to stabilize the vehicle (200).

In an embodiment for a helicopter or gyro glider, the connecting linkage (105) of the bridle (100) is configured to be adjacent to, on the left and right sides of the rotor mast or swashplate of the vehicle (200) at a point just below the rotor blades. Using the two halves of the connecting linkage (105), the moment arm of the bridle, between the bridle's pivot point (P) and the Center of Pressure (CP)/Center of Lift (CL) can be reduced to the absolute minimum possible. More particularly, the moment arm between the pivot point (P) and center of lift (CL) is smaller which allows the vehicle (200) to more easily pitch forward and backward and roll side to side.

Since, the moment arm between the bridle pivot point (P) and the Center of Lift (CL) is relatively small, the vehicle (200) can pitch, roll and yaw more easily. Therefore, when the vehicle (200) rolls, pitches, or yaws in different directions, the side linkages (110) of the bridle (100) remain parallel to the rope (120), and the rope (120) attached thereto remains taut. As a result, the control authority of the vehicle (200) is not altered unduly to the bridle (100), and in many cases is enhanced. More particularly, the collective forces and the resulting smaller moment arm acting on the bridle pivot point (P) can easily allow it to pitch from −10 degrees in a forward direction to +50 degrees in backwards direction, much farther than with traditional bridles. Further, the vehicle (200) is free to roll and yaw within the width of the bridle between the two side linkages (110). FIG. 4 depicts unconstrained side to side roll action (A) of the vehicle (200) pivoting around the bridle pivot point (P) in between the side linkages (110).

Attaching the bridle (100) with the two halves of connecting linkage (105) allows space therebetween for the swashplate, actuators, communication box, the battery and alternator, and the payloads of the vehicle (200) while functionally placing the bridle's pivot point (P) near the Center of the two halves of the rigid connecting linkage (105), right under the rotor (R). Without the two halves of the connecting linkage (105) it would be impossible to attach a tether (120) or lift a load from this location as this location is typically occupied by the rotor shaft, engine, and transmission and/or swashplate mechanics.

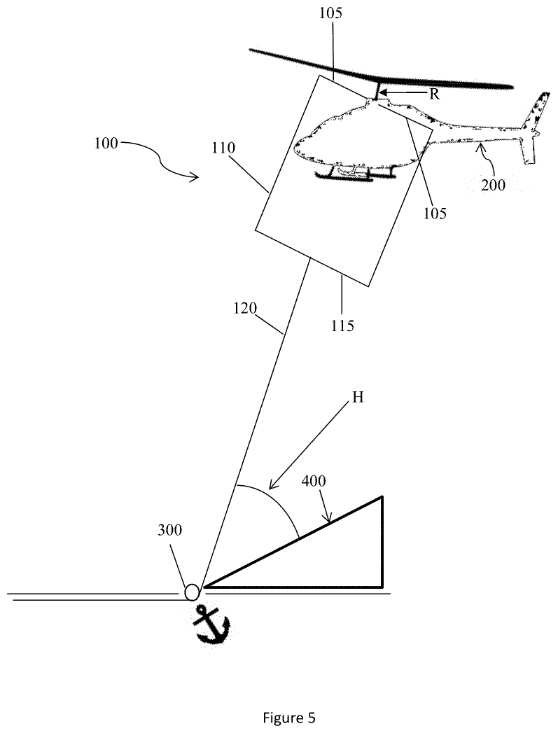

The tether (120) refers to generally a flexible elongate element secured between vehicle such as a helicopter, drone, or aircraft. A part of the element may also be rigid. In an embodiment, the tether (120) is of a flexible material selected from the group consisting of crystalline plastics, ultra-high molecular weight polyethylene, aramid, carbon fiber, a composite material, and any combination thereof. In another embodiment, the tether (120) is of an inflexible solid material such as rod. In the case of a rod, the tether (120) the bridle pivot point (P) is a universal joint or similar. The solid rod is used to affix optional landing gear or to facilitate landing of the vehicle (200) on a fixture as described in FIGS. 5, 6 and 7.

In an embodiment, the linkages (105, 110, and 115) are formed by wire rope and sleeve type structure. In an embodiment, the wire rope is made of a flexible material selected from the group consisting of braided steel, stainless steel, galvanized steel, nylon coated wire rope, and fiber polyvinyl chloride coated (PVC) wire rope, crystalline plastics, ultra-high molecular weight polyethylene, aramid, carbon fiber, a composite material, and any combination thereof. In an embodiment, the sleeve is made of sections of steel pipe, plastic, or sheet metal to provide reinforcement to the entire bridle structure. In an embodiment, the wire rope is continuous bridle structure. In an embodiment, the wire rope is discontinuous, i.e., the wire rope is secured at joints or welded at joints to form the bridle structure. In an embodiment, the sleeve is discontinuous.

In an embodiment, the pivot point (P) is a bolt having a head and a shank. The shank has a recess configured thereon. A sleeve is configured to be provided to freely rotate in the recess. In another embodiment, either the tether (120) is connected to the sleeve or the fixture is connected to the sleeve.

In an embodiment, the rotor (R) can be controlled in pitch, roll, and yaw by means one of, or a combination of a swashplate, a spider hub, a delta hub, mast tilt control, bimetal actuators, servo flaps on the rotor blades or other rotorcraft control means either located above or below the rotor head or optionally inside the rotor blades and/or rotor head.

The bottom linkage (115) is configured to be attached to the side linkages (110) to form a bridle structure. In an embodiment, the side linkages (110) are flexible structures attached to the two halves of connecting linkage (105) and the bottom linkage (115) via universal type flexible joints. In another embodiment, side linkages (110) are rigid structures attached to the two halves of connecting linkage (105) and the bottom linkage (115) via wire ropes. The bottom linkage (115) is rigid and transfers the tension in the bridle (100) to the tether (120). Thus, the complete fixture resembles a rectangle that transfers the loads of the vehicle (200) from the bridle pivot point (P) to the tether attachment point (125). When the vehicle (200) pitches, rolls, or yaws, the rectangular fixture is free to change to more of a skew parallelogram shape. More specifically, the load path between the bridle pivot point (P) and the tether attachment point (125) on the bottom linkage (115) remains cantered maintaining the vehicle's stability in flight irrespective of the vehicle's flight attitude in pitch, roll or yaw within the parallelogram bridle (100). The tether (120) is configured to be attached to the bottom linkage at tether attachment point (125). The connecting linkage (105), the side linkages (110), the bottom linkage (115), and the tether (120) facilitate transfer of the loads of the vehicle (200) from the pivot point (P) to the tether attachment point (125) to make the vehicle (200) agile and to stabilize the vehicle (200).

In an embodiment, the fixture can have any required shape other than parallelogram and rectangle that creates the pivot point (P) close to the centre of lift (CL) of a rotor to allow the vehicle (200) to be scalable, agile and manoeuvrable.

In an embodiment, the overall length of the connecting linkage (105) is the same as the bottom linkage (115). In another embodiment, the length of the bottom linkage (115) could be longer or shorter than the connecting linkage (105). In yet another embodiment, the lengths of the top and bottom linkages (105, and 115) are equal. The above mentioned embodiments of the configuration of the connecting linkage (105) and the bottom linkage (115) can be varied as per the application of the bridle (100). In one embodiment, the linkages (105, 110, and 115) are connected with each other with the help of hinges.

In an embodiment, the rope (120) and side linkages (110) are of steel, polymer, or a synthetic material. In another embodiment the rope (120) and side linkages (100) may be rigid bodies. In another embodiment, wheels, skids or bearings are provided on the bottom linkage to allow the bridle (100) to be joined to the landing vehicle such as a boat or a truck.

The application of large controlling forces which would have been otherwise required for resisting the unstable forces acting on the vehicle (200) due to imbalance created by a conventional bridle's large moment arm are therefore negated.

In one embodiment, such as a tethered gyro glider, a tail with control surfaces such as an elevator, rudder, and wind vane and/or tail rotor is typically present and required. With the bridle (100) of the present disclosure the entire tail structure and control surfaces become optional as the bridle (100) and its bridle pivot point (P) are configured to make the entire tail unnecessary for controlled tethered flight.

In one embodiment, the bridle (100) includes a winch having a snatch block pulley, and configured to reel in or pay out the rope (120), as per the altitude of the vehicle (200) with respect to the external body. In another embodiment, an anchor is attached to the end of the rope (120), for anchoring the bridle (100) to an external body which may be a fixed or a towed platform, a ground based generator, an external load.

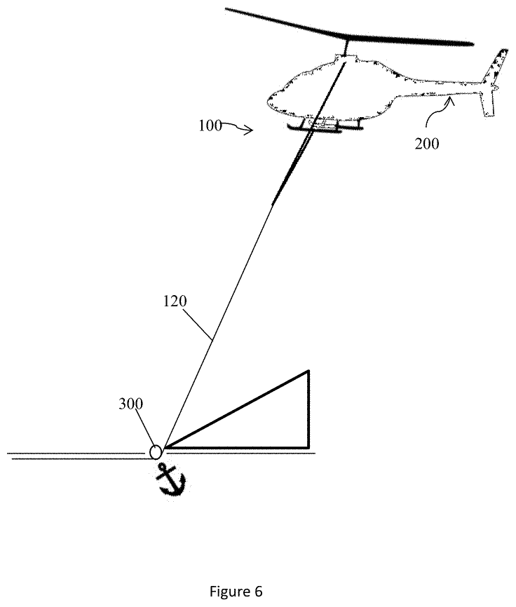

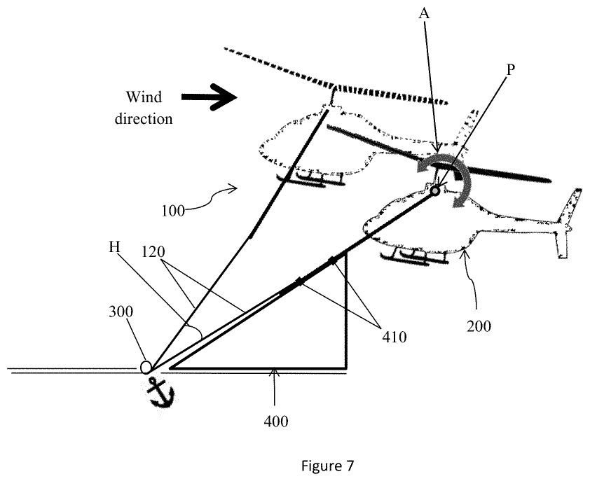

In an embodiment, wheels, skids or bearings are provided on the bottom linkage (115) to allow the bridle (100) to be joined to a landing vehicle (400) (as shown in FIGS. 5, 6, and 7). In another embodiment, a landing and launching fixture (300) is attached to the landing vehicle (400) via the side linkages (110) to facilitate landing and launching of the vehicle (200) without altering the flight stability of the bridle (100). This feature is critical aspect to the use of this improved bridle (100) as without it landing and launching airborne embodiments become problematic due to parts (110) and (115) suspended under the vehicle (200). The landing and launching fixture (300) is allowed to pivot 360 degrees to align itself with the tether (120) as the vehicle (200) gently comes in for a landing. The landing vehicle (400) such as a truck or boat that turns into the wind, when subjected to winds creates a high angle (H), and the fixture (300) aligns with the vehicle (400) to tether the vehicle (200) as it lands. The high angle (H) is located between the tether 120 and the horizontal ground surface (refer FIGS. 5 and 6). Further, in extreme fore and aft motion (A) the vehicle (200) arrives at the landing position and gently flies down, till the bridle (100), more specifically the side linkages (110) are securely anchored to landing and launching fixture (300) attached thereto with the help of locking clamps (410). The tether (120) forms a high angle (H) approaching to a low angle (L) engagement (refer FIG. 7).

On touch down, the locking clamps (410) immediately and securely latch on to rigid side linkages (110). On take-off, the locking clamps (410) hold the air vehicle (200) firmly, but still allow it to pitch fore and aft motion (A). When enough lift for safe take-off is sensed by a sensor (not shown in figures) connected to the locking clamps (410), the locking clamps (410) are released by a command generated by a controller or a processor (not shown in figures) and the vehicle (200) does an immediate jump style take off minimizing ground strike risk. The need for the vehicle (200) to carry a heavy landing gear, as well as the hazards involved in ground resonance type catastrophic destruction or bouncy landings is eliminated. Moreover, the reel in and the pay-out of the tether/rope (120) is made relatively simpler and safer, especially during launch and landing in heavy seas.

In one embodiment, in an inoperative configuration, the bridle (100) is configured to be tucked up in the vehicle (200), preferably below the fuselage, to act as a static rope or a ladder. In another embodiment, the bridle (100) is configured to be deployed from the inoperative configuration, and extended from within the cockpit of the vehicle (200) in an operative configuration where it can be suspended below the vehicle (200).

Therefore, attaching the pivot point (P) of the bridle (100) close to the center of lift of the vehicle (200) provides agility, stability and precise controllability to the vehicle (200) while being tethered to an external body. Further, the bridle (100) of the present disclosure has relatively better rolling, pitching and yaw stability and control. The bridle (100) requires less number of structural components, including making the entire tail structure and components optional. The bridle (100) provides better safety and control while launching and landing of the vehicle (200).

The bridle (100) connected to the vehicle (200) creates the pivot point (P) above the vehicle's (200) centre of gravity (CG) and below or at the centre of lift (CL) or at the centre of gravity (CG) of the vehicle (200) when the centre of lift (CL) is in the same approximate location of the centre of gravity (CG) of the vehicle (200) makes the vehicle agile and helps in stabilizing the vehicle (200).

The foregoing description of the embodiments has been provided for purposes of illustration and not intended to limit the scope of the present disclosure. Individual components of a particular embodiment are generally not limited to that particular embodiment, but, are interchangeable. Such variations are not to be regarded as a departure from the present disclosure, and all such modifications are considered to be within the scope of the present disclosure.

### Technical Advancements

The present disclosure described herein above has several technical advantages including, but not limited to, the realization of a bridle for a vehicle, which;
provides agility, stability and precise controllability to the vehicle while being tethered to an external body;
has relatively better rolling, pitching and yaw stability and control;
requires less number of structural components, including making the entire tail structure and components optional; and
provides better safety and control while launching and landing the vehicle.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

The use of the expression “at least” or “at least one” suggests the use of one or more elements or ingredients or quantities, as the use may be in the embodiment of the disclosure to achieve one or more of the desired objects or results.

Any discussion of materials, devices, articles or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

I claim:

1. A bridle for a vehicle, said bridle being connected to the vehicle and which creates a pivot point located at a location selected from:
a. above the vehicle's center of gravity and below or at the center of lift of the vehicle, when the center of gravity is located below the center of lift;
b. below the center of gravity of the vehicle and below or at the center of lift of the vehicle, when the center of gravity is located above the center of lift; and
c. at the center of gravity of the vehicle when the center of lift is in the same approximate location of the center of gravity of the vehicle.

2. The bridle according to claim 1, wherein said bridle includes a tether, and said tether is connected to the pivot point.

3. The bridle according to claim 1, wherein said bridle includes a tether and a fixture, wherein said fixture creates the pivot point and the tether is attached to the fixture.

4. The bridle according to claim 3, wherein said fixture comprises:
a. connecting linkages configured to be attached and create the pivot point;
b. side linkages configured to be attached to ends of said connecting linkage;
c. at least one bottom linkage configured to be attached to said side linkages to form a bridle structure; and
d. a tether configured to be attached to said bottom linkage at a tether attachment point, wherein said connecting linkage, said side linkages, said bottom linkage, and said tether facilitate transfer of the loads of the vehicle from the pivot point to the tether attachment point.

5. The bridle according to claim 4, wherein said two halves of connecting linkage has same length as said bottom linkage.

6. The bridle according to claim 4, wherein said bottom linkage is longer or shorter than said connecting linkage.

7. The bridle according to claim 4, wherein the overall length of said connecting linkage and said bottom linkage is same.

8. The bridle according to claim 4, wherein the lengths of said connecting linkage and said bottom linkage are equal.

9. The bridle according to claim 4, wherein said side linkages are flexible structures attached to said two halves of connecting linkage and said bottom linkage via universal type flexible joints.

10. The bridle according to claim 4, wherein said side linkages are rigid structures attached to said two halves of connecting linkage and said bottom linkage via wire ropes.

11. The bridle according to claim 4, wherein said bottom linkage is rigid that allows tension of said bridle to transfer to said tether.

12. The bridle according to claim 4, wherein said side linkages and said tether remains parallel to allow said tether to remain taut.

13. The bridle according to claim 4, wherein said tether and/or side linkage are of a flexible material selected from the group consisting of crystalline plastics, ultra-high molecular weight polyethylene, aramid, carbon fiber, a composite material, and any combination thereof.

14. The bridle according to claim 4, wherein said connecting linkages are in two halves on either side of the vehicle adjacent or at the pivot point.

15. The bridle according to claim 4, wherein said two halves of connecting linkage are pivoted near or in the hub of the vehicle.

16. The bridle according to claim 4, wherein said pivot point between said two halves of connecting linkages and the tether attachment point on said bottom linkage remains centered to stabilize the vehicle.

17. The bridle according to claim 4, wherein said tether is of an inflexible solid material such as a rod.

18. The bridle according to claim 1, wherein moment arm between the pivot point and center of lift is smaller to allow the vehicle to more easily pitch forward and backward and roll side to side.

19. The bridle according to claim 18, wherein said moment arm allows the vehicle to pitch from −10 degrees in a forward direction to +50 degrees in backwards direction.

20. The bridle according to claim 19, wherein said linkages are formed by wire rope and sleeve type structure.

21. The bridle according to claim 20, wherein said wire rope is made of a flexible material selected from the group consisting of braided steel, stainless steel, galvanized steel, nylon coated wire rope, fiber polyvinyl chloride coated wire rope, crystalline plastics, ultra-high molecular weight polyethylene, aramid, carbon fiber, a composite material, and any combination thereof.

22. The bridle according to claim 1, for use along with an aerial vehicle.

23. The bridle according to claim 1, for use along with an aquatic vehicle.

24. An aerial vehicle having a bridle according to claim 22 attached thereto.

25. An aquatic vehicle having a bridle according to claim 23 attached thereto.
